(19) United States
(12) Patent Application Publication
(10) Pub. No.: US 2016/0081517 A1
(43) Pub. Date: Mar. 24, 2016

(54) NOVEL CONTAINER DESIGN WITH BUILT-IN OVERRUN METER

(71) Applicant: TANGENT FOODS INTERNATIONAL LIMITED, Grand Cayman (KY)

(72) Inventor: Jareer Mansour Abu-Ali, Phitsaulok (TH)

(73) Assignee: TANGENT FOODS INTERNATIONAL LIMITED, Grand Cayman (KY)

(21) Appl. No.: 14/862,742

(22) Filed: Sep. 23, 2015

Related U.S. Application Data
(60) Provisional application No. 62/054,392, filed on Sep. 24, 2014.

(51) Int. Cl. A47J 47/08; B65D 43/02; B65D 81/18; B65D 3/06

(52) U.S. Cl. CPC A47J 47/08; B65D 3/06; B65D 43/02; B65D 81/18

(57) ABSTRACT

The present invention describes a novel packaging container with a dual purpose used in conjunction with ice cream and frozen dessert mixes that do not require the use of ice cream machines. The container acts as a primary or secondary packaging for the powdered mixes in its first role, and as a foam creation and whisking vessel that contains indicators critical to the proper operation of the mixes, such as target overrun run level and or whisking target indicators for various types of desserts made using the mixes. The Container may contain optional modifications, such as static mixers and homogenizers, that enhance the performance of the mixes and improve the stability and quality of the finished product. The container can be made from a variety of materials in a variety of shapes.

Ice cream and related frozen dairy and non-dairy desserts are a major food industry with estimated annual sales approaching 66 billion USD annually. Ice cream is thought to have originated in the time of the ancient Romans. There have been recorded histories of Emperor Nero ordering ice to be brought down from the mountains and then mixed with fruits or honey and consumed as a refreshing dessert. Modern ice cream and similar frozen desserts are reported to have first originated in Arabia or Persia, where craftsmen would mix cream with sugar, yogurt and rose water then chill the resulting mix by adding it to ice.

The Chinese are credited with inventing the first systematic methods to produce where they would add the ingredients into metal pots and place the pots in a mixture of ice and salt which depresses the freezing point of the ice and causes the sweetened mixture inside to freeze more solid.

The first patent for the modern mechanized machine for making ice cream was granted to Nancy Johnson of Philadelphia in 1843. Mrs. Johnson's hand-cranked machine utilized the same principles being used today for home and commercial ice cream manufacturing.

Ice Cream is a foam and a solution and a colloidal suspension all at once. It is basically a foam where the air bubbles are suspended in a solution containing the sweetener and where the walls of the air bubbles are surrounded by fat particles and protein particles which act simultaneously as an emulsifier and a separator between fat particles at the surface of the air bubbles.

In Modern ice cream making where a machine is used there are several steps used including:
1. Mixing dry ingredients with liquid ingredients (most commonly milk and Cream)
2. Pre-heating
3. Homogenization
4. Pasteurization
5. Cooling
6. Storage (Aging)
7. Crystallization (Where Aeration takes place and may involve pressurized air injection)
8. Further cooling
9. Packaging
10. Hardening
11. Storage and distribution

This is the general industrial and commercial process. Home ice cream making will usually exclude steps 3,4,8, 9 and 11. In home ice cream making the dry ingredients are mixed with the liquid ingredients (can be heated and aged at this stage) and are added as a solution to an ice cream machine containing a refrigerated drum with a central mixing shaft. As the mixing shaft and/or the drum rotate, the solution beings to freeze (crystallization) due to contact with the internal walls of the refrigerated drum. As the solution rotates and freezes, the mixing shaft scrapes the mixture from the walls and blends back into the center thus entrapping air.

The entrapped air is critical to the properties and qualities of ice cream and associated and similar frozen desserts. the entrapped air gives the ice cream body, firmness and lightness all at once. without air, ice cream and associated frozen desserts would be very dense and very hard (similar to frozen milk) or would require large amounts of fat to maintain their malleability which increases their denseness; this will also affect the nutritional profile of the finished produce per serving. The amount of air in ice cream and associated frozen desserts in measured in % Overrun. % Overrun is generally defined as follows:

% Overrun=(Vol. of ice cream−Vol. of liquid mixture)/Vol. of Liquid mixture×100%

Due to the dramatic impact of overrun on ice cream, its measurement is important. In industrial operations, overrun is quantified either automatically or through volumetric QA measurements using lab equipment.

By their nature, modern ice cream making systems are energy intensive and cumbersome, necessitating large amounts of energy to handle and prepare the ingredients and then more energy in the ice cream machines as these machines try to rapidly and controllably freeze the solution while aerating it before the fat can fully coalesce. Because of this nature and the need to store and prep the ingredients in steps such homogenization, ice cream factories usually will occupy large physical footprints and require significant capital investment which in turn limits entry into the market and inhibits innovation.

The energy consumption associated with ice cream, and related frozen dairy desserts, comes with a heavy environmental impact in terms of pollution. The need to maintain the product in frozen condition throughout its distribution and sales cycle and the use of often non-recyclable containers further adds to environmental impact.

By contrast, home ice cream making machines require relatively less energy overall, require less footprint and have less impact on the environment; they do however produce lower stability products, at lower rates, with significantly less overrun, producing much smaller quantities per unit of time. They also tend to be messy and cumbersome which limits their use as an alternatives to industrial Ice cream.

This has led to the rise of the no-machine-required mixes; By conceptually deconstructing ice cream, stabilizing the components and reincorporating into stable, easily manipulated products, this class of ice cream and frozen dessert mixes seeks to present an alternative method to produce and distribute ice cream and related frozen desserts that would be dramatically cheaper and have a significantly lower environmental impact. In these products, the ice cream process is reconfigured, with a semi-stable foam being created as a first step from mixing dry and liquid ingredients. the Foam requires a target amount of air to be incorporated into it to be stable and prevent fat globules from coming so close together as to form an oily mouth feel. This target varies based on the composition of the liquid used in preparation and is inversely proportional to amount of fat in the liquid; higher fat liquids will require and be able to hold less air while lower fat products will require more and be able to hold more air to be stable. This foam is then frozen using available freezing equipment, the foams created are designed to be stable to the slow freezing rates of home freezers.

Because these products rely so heavily on reaching a target overrun, and because they are primarily targeted at home users who are not technical experts, a simple method to determine target overrun is required. This invention entails a packaging container that acts as a primary or secondary packaging for these no-machine-needed mixes. The powdered no-machine-needed frozen dessert and ice cream mixes are packaged, distributed and sold inside these containers. The container is marked with indicator levels that show the target expansion (overrun) levels for the various types of liquid used in combination with the mixes. the user adds liquid to the container to a marked level, they then add the powder mix to the liquid. An aerating device such as a whisk or beaters (manual or automated) is inserted into the container and the mixture is aerated till the mixture reaches the marked overrun target for the liquid used. After the Target overrun is reached, the aerating device is removed and the resulting foam is frozen.

The Container can have static mixers and/or homogenizers built into the walls of the container to speed up the whisking process and improve the quality of the final product.

Materials used in making the container include but are not limited to:
Paper
Cardboard
Plastic
Metal
Carbon fiber
Glass
Polymers
Wood
   Shapes of the container include but are not limited to:
Cylinder
Circular cylinder
Oval cylinder
Elliptical cylinder
Elliptical frustum
Elliptical conical frustum
Frustum
Conical Frustum
Pyramidal Frustum
Cube
Square cube
Rectangular cube
Hemisphere
Semi sphere
Spherical segment
Spherical cap
Tubular

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The entire disclosures of all applications, patents and publications, cited herein and of corresponding U.S. Provisional Application Ser. No. 62/054,392, filed Sep. 24, 2014, are incorporated by reference herein.

From the foregoing description, one skilled in the art can easily ascertain the essential characteristics of this invention and, without departing from the spirit and scope thereof, can make various changes and modifications of the invention to adapt it to various usages and conditions.

### BRIEF DESCRIPTION OF FIGURES

FIG. 1 represents the container of the invention.

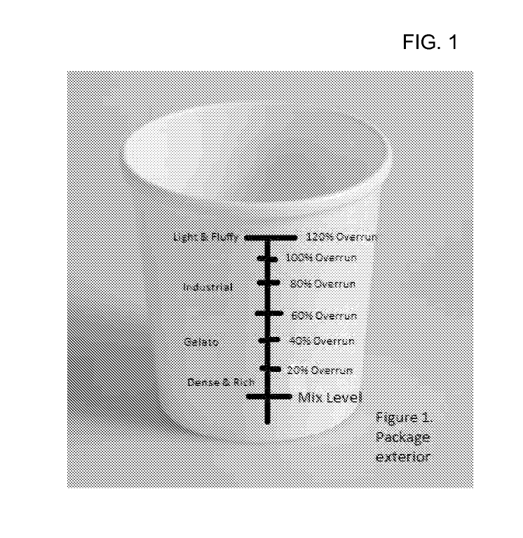

FIG. 2 represents the cross section of package with divider

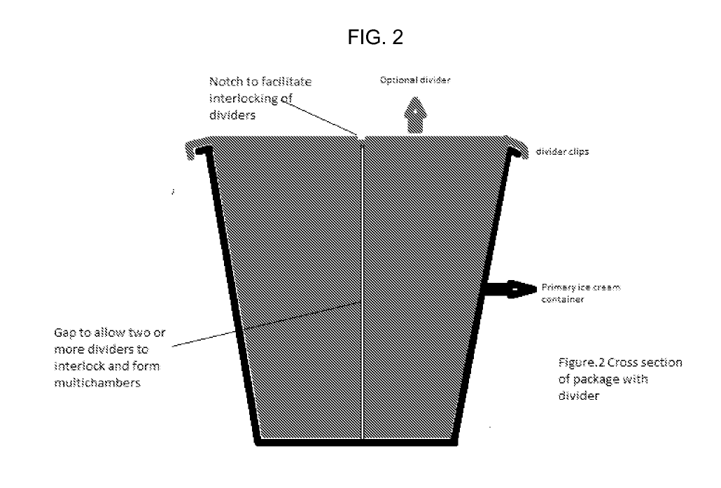

FIG. 3 represents the package cross section without divider and containing static mixers and homogenizers

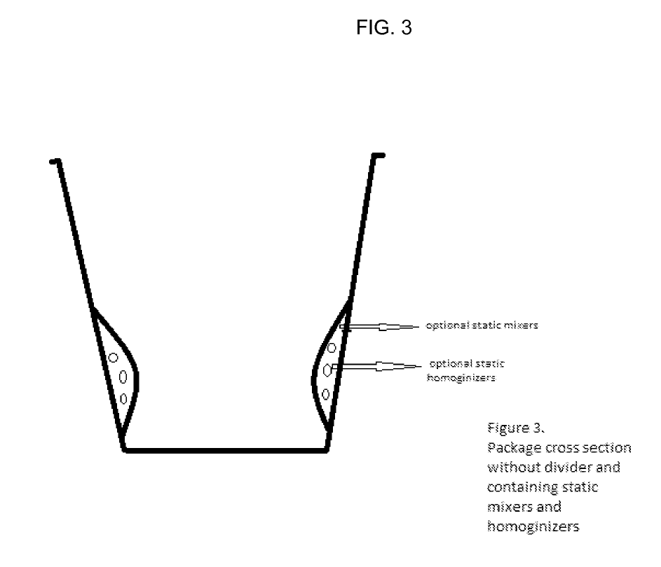

1. A packaging container for use as a packaging and whisking vessel for no-machine-needed ice cream and frozen dairy and non-dairy desserts wherein the container includes:
a plurality of markers indicating a target overrun and whisking targets for a plurality of types of liquid used with no-machine-needed mixes.

2. The packaging container for use as a packaging and whisking vessel for no-machine-needed ice cream and frozen dairy and non-dairy desserts of claim 1, wherein the container has smooth sides and a flat bottom.

3. A packaging container for use as a packaging and whisking vessel for no-machine-needed ice cream and frozen dairy and non-dairy desserts wherein the container includes:
side walls;
a bottom; and
protrusions or indentations on the side walls or the bottom of the container, the protrusions or indentations configured to:
help facilitate mixing,
act as static mixers or act as static homogenizers, or
reduce globule/droplet size.

4. The packaging container of claim 1, wherein the container includes a lid.

5. The packaging container of claim 1, wherein the container includes a covering or closure.

6. The packaging container of claim 5, wherein the covering or the closure is attached to the container.

7. The packaging container of claim 5, wherein the covering or the closure is detachable from the container.

8. The packaging container of claim 3, wherein the protrusions or indentations have at least one of the following shapes:
straight, perforated straight, angled, irregular-shaped, wavy, hill-shaped, perforated hill-shaped, ring-shaped, multi-ring shaped, pumps, or needle.

9. The packaging container of claim 3, wherein the protrusions or indentations extend along the side walls.

10. The packaging container of claim 3, wherein the protrusions or indentations extend along the bottom.

11. A packaging container for use as a packaging and whisking vessel for no-machine-needed ice cream and frozen dairy and non-dairy desserts, the container comprising:
side walls;
a bottom;
a plurality of markers indicating a target overrun and whisking targets for types of liquid used with no-machine-needed mixes; and
protrusions or indentations on the side walls or the bottom of the container, the protrusions or indentations configured to
help facilitate mixing,
act as static mixers or act as static homogenizers, or
reduce globule/droplet size.
